(19) United States
(12) Patent Application Publication
(10) Pub. No.: US 2012/0311250 A1
(43) Pub. Date: Dec. 6, 2012

(54) ARCHITECTURE AND ACCESS METHOD OF HETEROGENEOUS MEMORIES

(75) Inventors: Chieh-Lin CHUANG, Hsinchu City (TW); Wen-Hsiane Lin, Zhubei City (TW)

(73) Assignee: NOVATEK MICROELECTRONICS CORP., Hsinchu (TW)

(21) Appl. No.: 13/484,251

(22) Filed: May 30, 2012

(30) Foreign Application Priority Data
May 31, 2011 (CN) 100119097
May 31, 2011 (TW) 100119097

(51) Int. Cl. G06F 12/00

(52) U.S. Cl. 711/105; 711/154; 711/E12.001

(57) ABSTRACT

A heterogeneous memory architecture includes a first memory, a second memory and a memory controller. The first memory has a first memory space. The second memory has a second memory space larger than the first memory space. The memory controller is used for accessing common address space of the first memory and the second memory in a 2X-bit bandwidth, and for disabling the first memory and accessing non-common address space of the second memory in opposite to the first memory in a X-bit bandwidth, X being a positive integer.

This application claims the benefit of Taiwan application Serial No. 100119097, filed May 31, 2011, the subject matter of which is incorporated herein by reference.

### BACKGROUND

1. Technical Field

The invention relates in general to architecture and an accessing method of a heterogeneous memory.

2. Background

In general memory architecture of the present field, one single memory controller supports only one dynamic random access memory, or multiple dynamic random access memories having the same memory space. However, two independent memory controllers are required to support two dynamic random access memories having different memory spaces. Consequently, it complicates control of the heterogeneous memory architecture and makes the cost stay high.

### SUMMARY

The disclosure is directed to architecture and an accessing method of a heterogeneous memory, capable of utilizing one single memory controller to simultaneously support two memories having different memory spaces.

According to a first aspect of the present disclosure, a heterogeneous memory architecture is provided. The heterogeneous memory architecture includes a first memory, a second memory and a memory controller. The first memory has a first memory space. The second memory has a second memory space larger than the first memory space. The memory controller is used for accessing common address space of the first memory and the second memory in a 2X-bit bandwidth, and for disabling the first memory and accessing non-common address space of the second memory in opposite to the first memory in a X-bit bandwidth, X being a positive integer.

According to a second aspect of the present disclosure, a heterogeneous memory accessing method, applied to heterogeneous memory architecture, is provided. The heterogeneous memory architecture includes a first memory, a second memory and a memory controller. The first memory has a first memory space, and the second memory has a second memory space larger than the first memory space. The heterogeneous memory accessing method includes the following steps. The memory controller is utilized to access common address space of the first memory and the second memory in a 2X-bit bandwidth, X being a positive integer. The memory controller is utilized to disable the first memory and access non-common address space of the second memory in opposite to the first memory in a X-bit bandwidth.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing heterogeneous memory architecture according to an embodiment.

FIG. 2 is a flow chart of a heterogeneous memory accessing method according to an embodiment.

### DETAILED DESCRIPTION OF THE INVENTION

The disclosure proposes architecture and an accessing method of a heterogeneous memory, capable of utilizing one single memory controller to simultaneously support two memories having different memory spaces by disabling the memory with a smaller memory space as non-common address space is accessed.

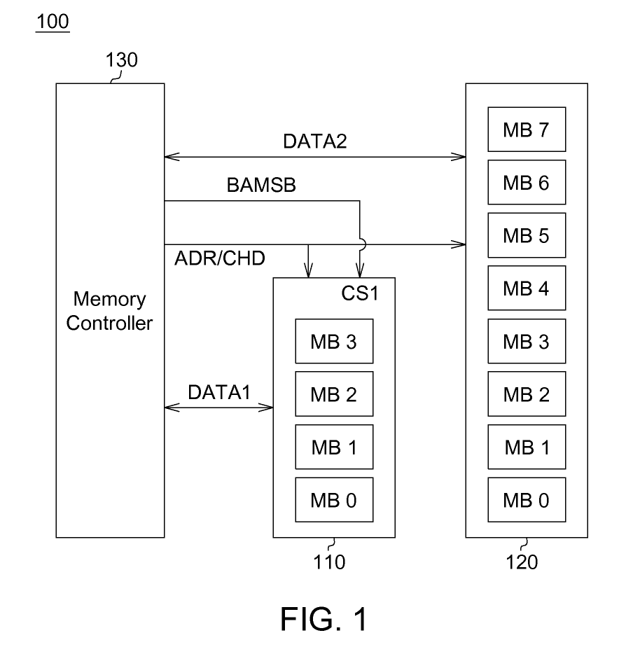

Referring to FIG. 1, a schematic illustration showing heterogeneous memory architecture according to an embodiment is shown. The heterogeneous memory architecture 100 includes a first memory 110, a second memory 120 and a memory controller 130. The first memory 110 and the second memory 120 are dynamic random access memories (DRAMs), for example. The first memory 110 has a first memory space; the second memory 120 has a second memory space larger than the first memory space. In the embodiment, take the size of the first memory space being 64 MB and the size of the second memory space being 128 MB as being exemplified without limitation.

Then assume that the first memory 110 and the second memory 120 have different numbers of memory banks, and the size of each memory bank is 16 MB, but it is not limited thereto. In actual, not only different numbers of the memory banks but also different numbers of pages in one memory bank or different numbers of bits in one page lead to different memory spaces of the first memory 110 and the second memory 120.

As shown in FIG. 1, the first memory 110 has four memory banks, MB0-MB3, and the second memory 120 has eight memory banks, MB0-MB7. Consequently, common address space of the first memory 110 and the second memory 120 is MB0-MB3, and non-common address space of the second memory 120 in opposite to the first memory 110 is MB4-MB7. For the common address space, a most significant bit (MSB) of its bank address is “0”, and for the non-common address space, a most significant bit of its bank address is “1”. Likewise, as the first memory 110 and the second memory have different memory spaces due to different numbers of pages in one memory bank or different numbers of bits in one page, it may be designed that, for the common address space, a most significant bit (MSB) of its page address or its bit address is “0”, and for the non-common address space, a most significant bit of its page address or its bit address is “1”, due

Hence, as the memory controller 130 accesses the common address space, the memory banks MB0-MB3, of the first memory 110 and the second memory 120, the memory controller 130 outputs a most significant bit BAMSB, “0”, of a bank address to a chip select pin CS1 of the first memory 110 to enable the first memory 110. Consequently, the memory controller 130 can simultaneously access data at the same address of the common address space, the memory banks MB0-MB3, of the first memory 110 and the second memory 120 via address/instruction signals ADR/CMD. Assume that a bandwidth of one single memory is 16 bits, then the memory controller 130 accesses data in the common address space, the memory banks MB0-MB3, in a 32-bit bandwidth.

As the memory controller 130 accesses the non-common address space, the memory banks MB4-MB7, of the second memory 120 in opposite to the first memory 110, the memory controller 130 outputs a most significant bit BAMSB, “1”, of a bank address to the chip select pin CS1 of the first memory 110 to disable the first memory 110. Consequently, the memory controller 130 can individually access data in the non-common address space, the memory banks MB4-MB7, of the second memory 120 via address/instruction signals ADR/CMD, without accessing the first memory 110 to cause the failed access. At this time, the memory controller 130 accesses data in the non-common address space, the memory banks MB4-MB7, in a 16-bit bandwidth.

In conclusion, the memory controller 130 accesses the common address space in a 2X-bit bandwidth, and automatically switches to access the non-common address space in a X-bit bandwidth. Therefore, the memory controller 130 can simultaneously support two memories having different sizes without an additional memory controller, thus simplifying the memory architecture and reducing the cost.

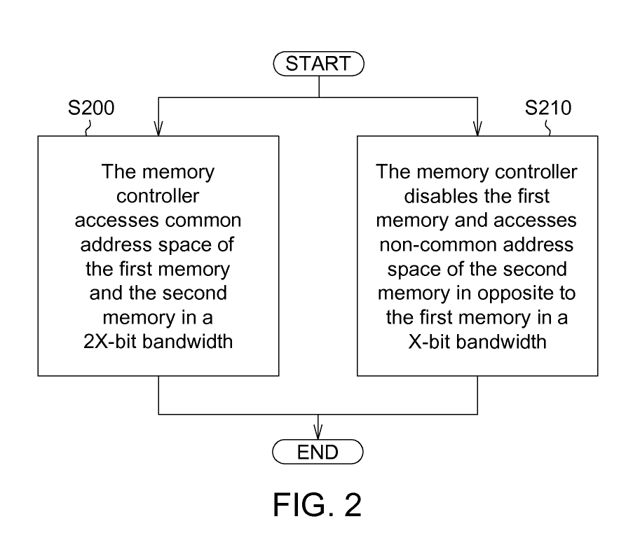

The disclosure further proposes a heterogeneous memory accessing method applied to heterogeneous memory architecture. The heterogeneous memory architecture includes a first memory, a second memory and a memory controller. Referring to FIG. 2, a flow chart of a heterogeneous memory accessing method according to an embodiment is shown. In step S200, the memory controller accesses common address space of the first memory and the second memory in a 2X-bit bandwidth, X being a positive integer. In step S210, the memory controller disables the first memory and accesses non-common address space of the second memory in opposite to the first memory in a X-bit bandwidth.

The detailed principles of the above heterogeneous memory accessing method have been described in the heterogeneous memory architecture 100 and the related contents, so detailed description thereof will be omitted.

The architecture and accessing method of a heterogeneous memory proposed in the above disclosure utilizes a most significant bit of a bank address, a page address or a bit address of the different memory spaces of the heterogeneous memory to disable the memory having a smaller memory space as accessing the non-common address space, thus capable of utilizing one single memory controller to simultaneously support two memories having different memory spaces without an additional memory controller. Therefore, the memory architecture is simplified and the cost is decreased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A heterogeneous memory architecture, comprising:
a first memory, having a first memory space;
a second memory, having a second memory space larger than the first memory space; and
a memory controller, for accessing common address space of the first memory and the second memory in a 2X-bit bandwidth, and for disabling the first memory and accessing non-common address space of the second memory in opposite to the first memory in a X-bit bandwidth, X being a positive integer.

2. The heterogeneous memory architecture according to claim 1, wherein the first memory and the second memory are dynamic random access memories.

3. The heterogeneous memory architecture according to claim 1, wherein the first memory has 2^{m-1} memory banks, the second memory has 2^{m} memory banks, m is a positive integer, and the memory controller outputs a most significant bit of a bank address to a chip select pin of the first memory to disable the first memory as accessing the non-common address space, and to enable the first memory as accessing the common address space.

4. The heterogeneous memory architecture according to claim 1, wherein the first memory has 2^{m-1} memory pages, the second memory has 2^{m} memory pages, m is a positive integer, and the memory controller outputs a most significant bit of a page address to a chip select pin of the first memory to disable the first memory as accessing the non-common address space, and to enable the first memory as accessing the common address space.

5. The heterogeneous memory architecture according to claim 1, wherein the first memory has 2^{m-1} memory bits, the second memory has 2^{m} memory bits, m is a positive integer, and the memory controller outputs a most significant bit of a bit address to a chip select pin of the first memory to disable the first memory as accessing the non-common address space, and to enable the first memory as accessing the common address space.

6. A heterogeneous memory accessing method, applied to a heterogeneous memory architecture comprising a first memory, a second memory and a memory controller, the first memory having a first memory space, the second memory having a second memory space larger than the first memory space, the heterogeneous memory accessing method comprising:
utilizing the memory controller to access common address space of the first memory and the second memory in a 2X-bit bandwidth, X being a positive integer; and
utilizing the memory controller to disable the first memory and access non-common address space of the second memory in opposite to the first memory in a X-bit bandwidth.

7. The heterogeneous memory accessing method according to claim 6, wherein the first memory has 2^{m-1} memory banks, the second memory has 2^{m} memory banks, m is a positive integer, and the heterogeneous memory accessing method further comprises:
utilizing the memory controller to output a most significant bit of a bank address to a chip select pin of the first memory to disable the first memory as accessing the non-common address space, and to enable the first memory as accessing the common address space.

8. The heterogeneous memory accessing method according to claim 6, wherein the first memory has 2^{m-1} memory pages, the second memory has 2^{m} memory pages, m is a positive integer, and the heterogeneous memory accessing method further comprises:
utilizing the memory controller to output a most significant bit of a page address to a chip select pin of the first memory to disable the first memory as accessing the non-common address space, and to enable the first memory as accessing the common address space.

9. The heterogeneous memory accessing method according to claim 6, wherein the first memory has 2^{m-1} memory bits, the second memory has 2^{m} memory bits, m is a positive integer, and the heterogeneous memory accessing method further comprises:
utilizing the memory controller to output a most significant bit of a bit address to a chip select pin of the first memory to disable the first memory as accessing the non-common address space, and to enable the first memory as accessing the common address space.
